(19) United States
(12) Patent Application Publication
(10) Pub. No.: US 2003/0079571 A1
(43) Pub. Date: May 1, 2003

(54) Ratchet crank

(76) Inventor: Jose P. Balajadia, New York, NY (US)

Correspondence Address: Jose P. Balajadia, Apt. 3J, 61-15 98 Street, Rego Park, NY, 11374, US

(21) Appl. No.: 10/021,385

(22) Filed: Oct. 29, 2001

(51) Int. Cl. B25B 13/46

(52) U.S. Cl. 81/60

(57) ABSTRACT

A ratchet crank, operated by a ratchet and pawl, is made from a bicycle freewheel that is modified to have a handle integral to the rotating drum, in lieu of the sprockets. It is used for turning continuously a wheel's hub, a wheel's axle and a crankset's axle/spindle with a gear, in vehicle on land and/or water; by a backward and forward movement of its handle.

When the handle is pulled back, the pawls slide over the ratchets; and when the handle is pushed forward, the pawls catch in the ratchets, taking them along forward.

Ratchet cranks have different shapes of central openings depending on the shape of the object it is applied to.

Vehicles may have one or two ratchet crank in use. When only one is in use, the handle may be lengthen for an operator in a standing or sitting position. Or, the handle may be short for an operator in a standing or sitting position.

With two ratchet cranks, a left hand side and a right hand side are in use. A pivot assembly that is arrached to the body of the vehicle is needed to make the two ratchet cranks alternately move up and down.

### (b) CROSS REFERENCE TO RELATED APPLICATION

Not Applicable.

### (c) STATEMENT REGARDING FEDERALLY SPONSORED RESEARCH AND DEVELOPMENT

Not Applicable.

### (d) BACKGROUND OF THE INVENTION

(1) Field of the Invention

This invention pertains to a way to turn continuously a wheel's hub, a wheel's axle, and a crankset's axle/spindle with a gear, without rotating a crank in a circular path, which is the usual way. A crank operated by a ratchet and pawl, is able to accomplish the same result by a backward and forward movement of the handle.

(2) Description of the Related Art

Three prior art are most relevant to this invention, namely: 1. bicycle crank, 2. bicycle freewheel, and 3. ratchet wrench.

1. The bicycle crank is used to rotate a crankset's axle/spindle with a gear, by rotating the crank in a circular path by pushing the pedals.

2. bicycle freewheel is attached to the rear wheel's hub. It permits the wheel to go on turning when the pedals are stopped. The bicycle freewheel has a round shape. Its freewheel body has a central opening that fits in a wheel's hub and is attached by threading it in. It has a rotating drum with sprockets on it. The sprocket gear and the chainwheel in the crankset are connected by a chain, so that when the pedals are pushed in a circular path, the chainwheel conveys the rotattion to the freewheel's sprockets, propelling the vehicle forward.

3. The ratchet wrench is a tool for tightening and loosening nuts and bolts by a backward and forward movement of its handle, without removal from it.

No patentability search was done on this invention.

By incorporating the operating mechanism of a bicycle freewheel or a ratchet wrench in a crank, the resulting device is a ratchet crank which can turn continuously a wheel's hub, a wheel's axle, and a crankset's axle/spindle with a gear in vehicles on land and/or water, by a backward and forward movement of the handle, without removal from the object it is applied.

### (e) BRIEF SUMMARY OF THE INVENTION

The ratchet crank can turn contimuously a wheel's hub, a wheel's axle, and a crankset's axle/spindle with a gear, in vehicles on land and/or water, by a backward and forward movement of the handle, without removal from it. With ratchet crank(s), one may operate while sitting or standing. When standing, one may operate by hand by using a longer handle; or while sitting down. Sitting or standing, one may operated by foot with short handle(s). With foot platform/pedal combination attached to the handle(s) and in conjunction with a pivot assembly, the two cranks move up and down alternately.

### (f) BRIEF DESCRIPTION OF THE SEVERAL VIEWS OF THE DRAWINGS

FIG. 1 is a front and perspective views of a bicycle crank, a prior art.

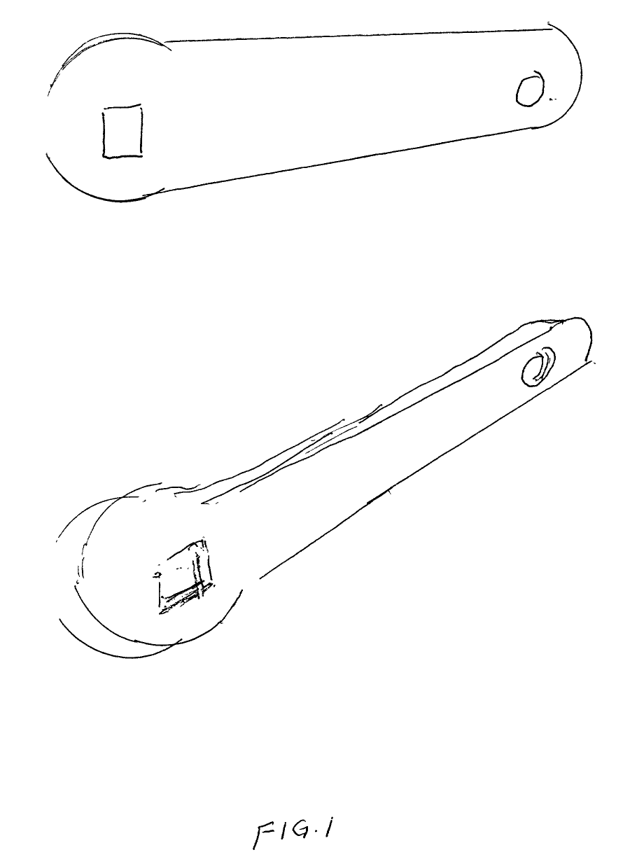

FIG. 2 is a front and perspective views of a bicycle freewheel, a prior art.

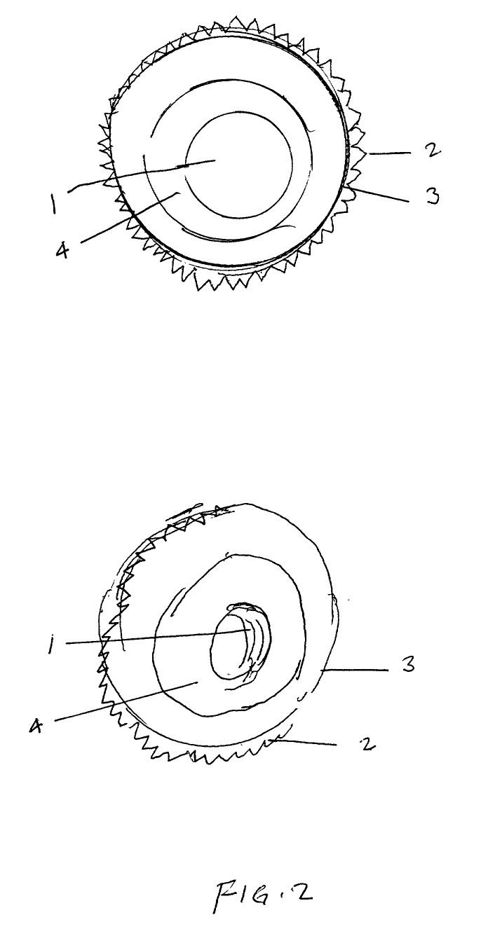

FIG. 3 is a front and perspective views of a ratchet wrench, a prior art.

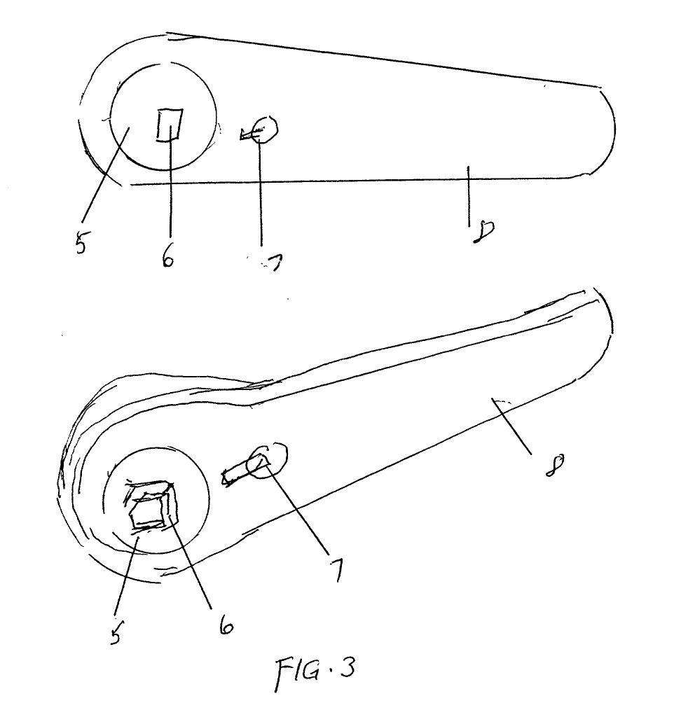

FIG. 4 is a front and perspective views of a modified bicycle freewheel, having a handle (12) at the rotating drum (11), in lieu of the sprockets. The central opening (9) fits in a wheel's hub, and is threaded.

FIG. 5 is a front and perspective views of a modified bicycle freewheel, having a central opening that fits in a wheel's axle (13) and is threaded.

FIG. 6 is a front and perspective views of a modified bicycle freewheel, having a central opening that fits in a crankset's axle/spindle with a gear ((17).

FIG. 7 is a front and perspective views of a ratchet wrench modified to have a size and shape having a central opening that fits in a wheel's hub (20) and threaded, in lieu of the flat, solid inner area with a solid cube at the center that fits a socket.

FIG. 8 is a front and perspective views of a modified ratchet wrench, having a central opening that fits in a wheel's axle (23).

FIG. 9 is a front and perspective views of a modified ratchet wrench, having a central opening that fits in a crankset's axle/spindle with a gear, (16).

FIG. 10 is a side and perspective views of a foot platform/pedal.

FIG. 11 is a front and perspective views of a pivot assembly.

### (g) DETAILED DESCRIPTION OF THE INVENTION

The invention is a ratchet crank, operated by a ratchet and pawl. It is used for turning continuously, a wheel's hub, a wheel's axle, and a crankset's axle/spindle with a gear, in vehicles on land and/or water, by a backward and forward movement of the handle, without removal from the object it is applied. Example of vehicles are: bicycles, motor bicycles, scooters, wheelchairs, cars, soap box cars, boats, canoes, and etc. This invention has two preferred embodiments, namely: (a) using a bicycle freewheel mechanism and (b) using a ratchet wrench mechanism.

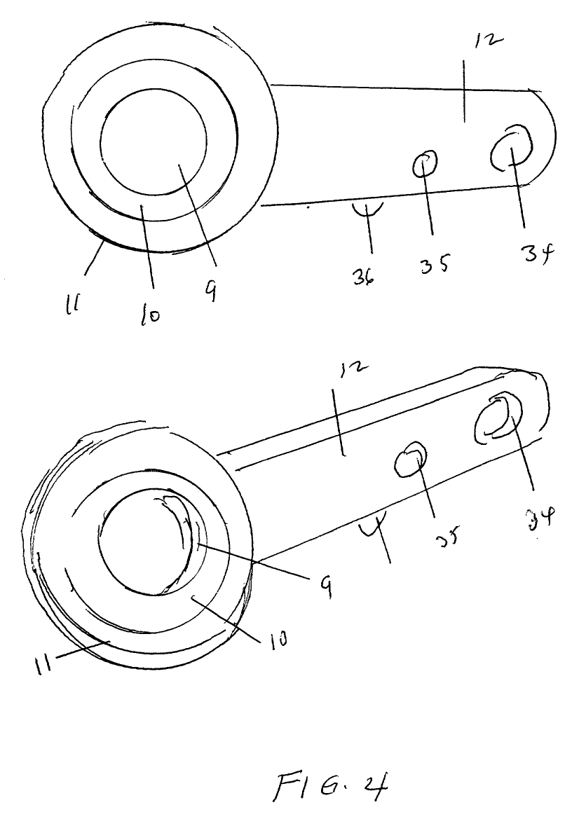

(a) Type 1 is a bicycle freewheel, modified by having a handle (9), in lieu of the sprockets, FIG. 4. The central opening (9) fits in a wheel's hub.

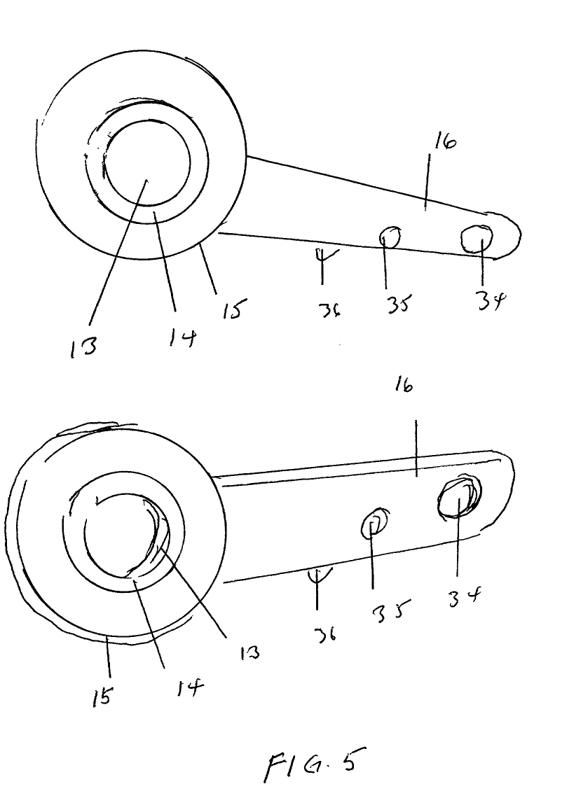

(a) Type 2 is a modified bicycle freewheel, having a central opening (13) that fits in a wheel's axle and is threaded, (FIG. 5).

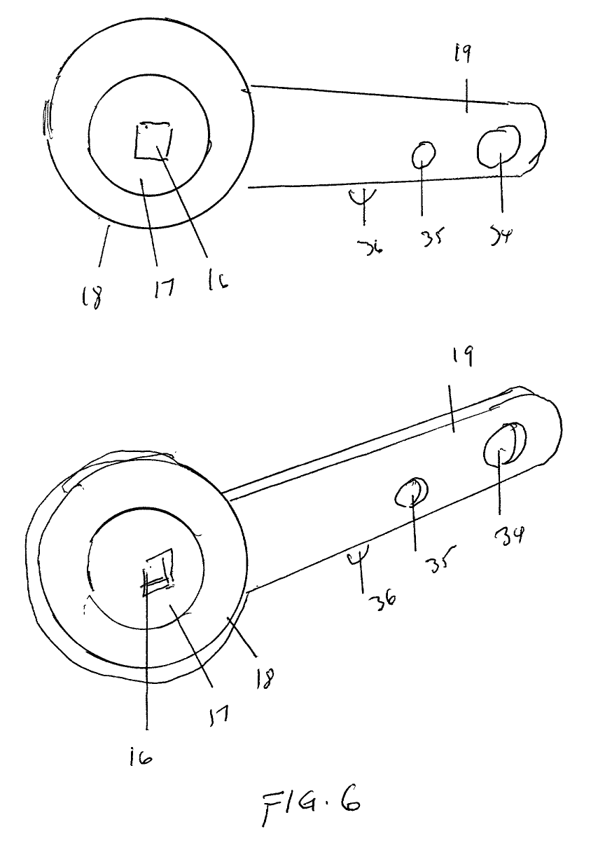

(a) Type 3 is a modified bicycle freewheel, having a central opening (16) that fits in a crankset's axle/spindle with a gear, FIG. 6.

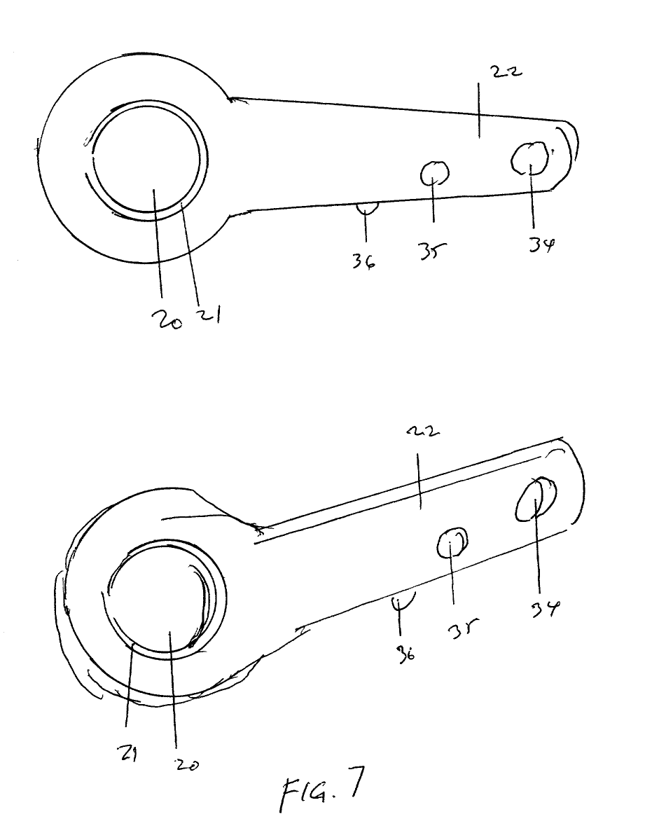

(b) Type 1 is a ratchet wrench, modified to have a size and shape to accommodate having a central opening that fits in a wheel's hub and threaded (20), in lieu of the flat, solid inner area with a solid cube for inserting a socket; and a handle (22), FIG. 7.

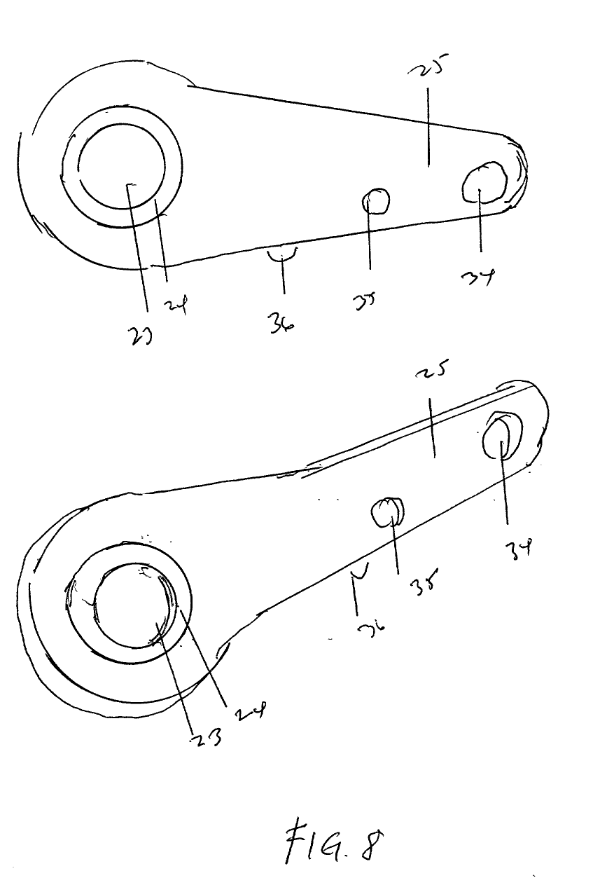

(b) Type 2 is a modified ratchet wrench, having a central opening that fits in a wheel's axle (23) in FIG. 8.

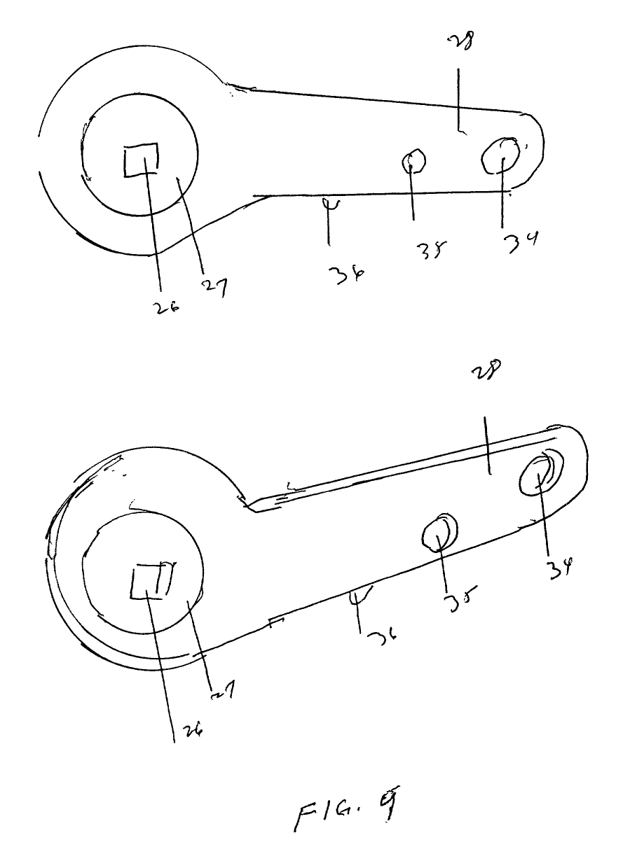

(b) Type 3 is a modified ratchet wrench, having a central opening that fits in a crankset's axle/spindle with a gear (26) FIG. 9.

Other devices having a ratchet and pawl mechanism may be converted into a ratchet crank.

The handle for all types of ratchet cranks are the same in design and features. A first opening in the handle, is a round, threaded opening (34) near the tip. A second opening, about 2 inches apart, is smaller, round, and not threaded. Underneath the side of the handle just an inch from the second opening, is a concaved protuberance.

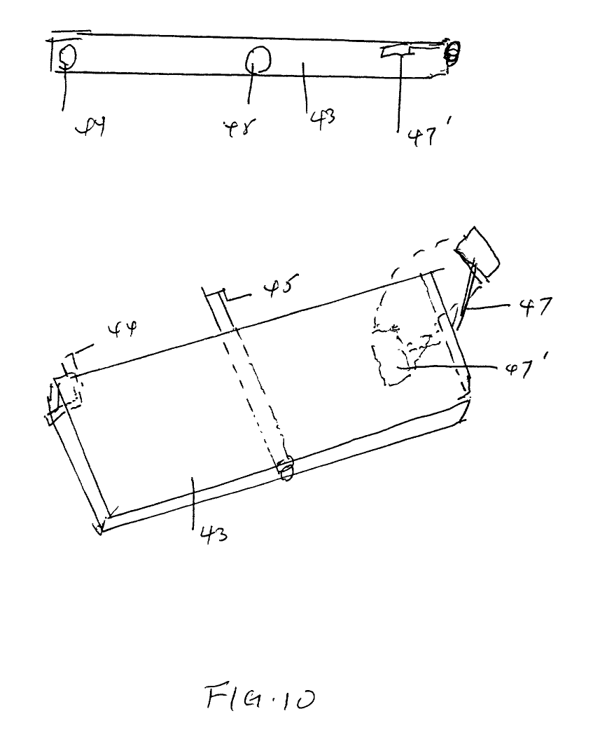

FIG. 10 is a foot platform/pedal combination attachable to the handle. It is a rectangular surface with a folding pedal. The axle (45) is attached to the handle's first opening (34) so that when an operator is standing, the platform is always in parallel position with the ground. When an operator would like to operate the vehicle in a sitting position, the locking pin (44) is inserted to the second opening in the handle (35) to prevent the platform/pedal from rotating when the pedal is up and pushed.

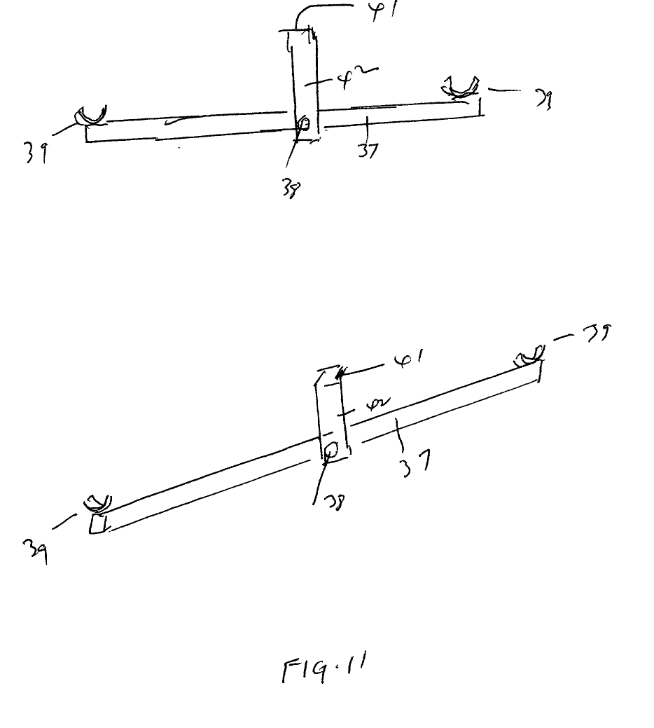

FIG. 11 is a pivot assembly. It is attached to a part of the vehicle's body at the top (41). The vertical part has an axle so that the horizontal bar (37) can swing up and down. At both ends, is a convexed disk (39) that touches the concaved protuberance (36) in the handle. This set up makes the platform/pedal move up and down. When two ratchet cranks are used, a left hand side and a right hand side, pushing down the right hand side will raise the left hand side and vice versa or alternately.

Some vehicles may be operated with only one ratchet crank in use. For example, in a scooter, with a short handle, the operator can push the handle by foot and a spring will make it go back up. Or the handle may be attached with an extension so that the operator can operate or move the handle while standing or sitting with one hand.

I claim:

1. A method of turning continuously a wheel's hub or a wheel's axle or a crankset's axle/spindle with a gear, in vehicles on land and/or water, comprising:
(a) converting a bicycle freewheel to function as a crank, by providing a handle at the rotating drum, in lieu of the sprockets,
(b) attaching with means the central opening to a wheel's hub,
(c) operating said crank, by a backward and forward movement of said handle, so that it may turn continuously the wheel's hub, without removal from it.

2. The method of claim 1, wherein the central opening fits in a wheel's axle, with means for attaching it to the wheel's axle.

3. The method of claim 1, wherein the central opening fits in a crankset's axle/spindle with a gear; with means for attaching it to a crankset's axle/spindle with a gear.

4. The method of claim 1, wherein the operating mechanism is that of a ratchet wrench, comprising: (a) providing a central opening that fits in a wheel's hub, by eliminating the central area which includes the cubical protuberance for inserting the sockets, (b) attaching with means said central opening to a wheel's hub.

5. The method of claim 4, wherein said central opening fits in a wheel's axle, with means for attaching it to a wheel's axle.

6. The method of claim 4, wherein said central opening fits in a crankset's axle/spindle with a gear, with means for attaching it to a crankset's axle/spindle with a gear.

7. The method of claims 1, 2, and 3, wherein the operating mechanism is that of a ratchet and pawl.

8. The method of claims 4, 5, and 6, wherein the operating mechanism is that of a ratchet and pawl.

9. A ratchet crank for turning continuously a wheel's hub or a wheel's axle or a crankset's axle/spindle with a gear, in vehicles on land and/or water, comprising:
(a) a bicycle freewheel converted to function as a crank, having a handle at the rotating drum, in lieu of the sprockets,
(b) means for attaching the central opening to a wheel's hub,
(c) means for operating said crank, by a backward and forward movement of said handle, so that it may turn continuously a crankset's axle/spindle with a gear, without removal from it.

10. The ratcvhet crank of claim 9, wherein the central opening fits in a wheel's axle, with means for attaching it to a wheel's axle.

11. The ratchet crank of claim 9, wherein the central opening fits in a crankset's axle/spindle with a gear, with means for attaching it to a crankset's axle/spindle with a gear.

12. The ratchet crank of claim 9, wherein the operating mechanism is that of a ratchet wrench, comprising: (a) a ratchet wrench converted to function as a crank, having a central opening that fits in a wheel's hub, in lieu of the solid central area with the cubical protuberance to which sockets are inserted,
(b) means for attaching said central opening to a wheel's hub,
(c) means for operating said crank, by a backward and forward movement of the handle, so that it may turn continuously a wheel's hub, without removal from it.

13. The ratchet crank of claim 12, wherein said central opening fits in a wheel's axle, with means for attaching it to a wheel's axle.

14. The ratchet crank of claim 12, wherein said central opening fits in a crankset's axle/spindle with a gear, with means for attaching it to a crankset's axle/spindle with a gear.

15. The method of claims 9, 10, and 11, wherein the operating mechanism is that of a ratchet and pawl.

16. The ratchet crank of claims 12, 13, and 14, wherein the operating mechanism is that of a ratchet and pawl.

17. Vehicles on land and/or water, using at least one ratchet crank to turn continuously a wheel's hub or a wheel's axle or a crankset's axle/spindle with a gear.

18. The vehicles of claim 17, wherein bicycles, motor bicycles, scooters, wheelchairs, cars, soap box cars, boats, canoes, are included among the others.
